(19) United States
(12) Patent Application Publication
(10) Pub. No.: US 2003/0173544 A1
(43) Pub. Date: Sep. 18, 2003

(54) Stabilizing compositions for polymer systems

(76) Inventor: Herbert Eichenauer, Dormagen (DE)

Correspondence Address: BAYER POLYMERS LLC, 100 BAYER ROAD, PITTSBURGH, PA, 15205, US

(21) Appl. No.: 10/385,078

(22) Filed: Mar. 10, 2003

(30) Foreign Application Priority Data
Mar. 15, 2002 (DE) 10212120.6
Mar. 15, 2002 (DE) 10212119.2
Mar. 15, 2002 (DE) 10212118.4

(51) Int. Cl. C09K 15/32; C08K 5/13; C08K 5/49

(52) U.S. Cl. 252/400.24; 524/115; 524/323

(57) ABSTRACT

A stabilizing composition that contains as an antioxidant a compound having in its molecular structure at least one sterically hindered phenol and a water-soluble inorganic salt of a phosphorus acid is disclosed. The composition is suitable for providing stability to a variety of polymeric resins. Also disclosed is a process for the production of thermally stable graft rubber polymers and molding compositions containing such grafts. The molding compositions are characterised by improved odoriferous behavior after processing.

### FIELD OF THE INVENTION

The present invention relates to stabilizing compositions and thermoplastic molding compositions thus stabilized.

### SUMMARY OF THE INVENTION

A stabilizing composition that contains as an antioxidant a compound having in its molecular structure at least one sterically hindered phenol and a water-soluble inorganic salt of a phosphorus acid is disclosed. The composition is suitable for providing stability to a variety of polymeric resins. Also disclosed is a process for the production of thermally stable graft rubber polymers and molding compositions containing such grafts. The molding compositions are characterised by improved odoriferous behavior after processing.

### BACKGROUND OF THE INVENTION

Synthetic polymers, in particular those with unsaturated bonds in the molecule chain, are decomposed by the action of oxidizing agents (e.g. oxygen, ozone), heat or light, as a result of which the properties are impaired and problems arise in the practical use of the molded articles produced from the polymers.

In order to prevent such a decomposition, numerous stabilizers for polymers have already been described (see for example EP-A 669 367 and the literature cited therein).

A particular problem and the first object of the present invention are the effective stabilization in an early stage of polymers produced in aqueous dispersion, aqueous emulsion or aqueous suspension.

It has now surprisingly been found that stabilizing compositions containing antioxidants with sterically hindered phenol groups and special water-soluble inorganic phosphorus compounds are particularly effective in stabilizing polymers produced in aqueous dispersion.

Graft rubber polymers, in particular graft rubbers for application areas such as for example impact modifiers for polymer systems, are often produced by the process of aqueous emulsion polymerisation, in which as a rule a drying process is necessary as the last working-up step.

In particular the rubber fraction contained in the graft rubber polymers exhibits a sensitivity to agents having an oxidizing effect (e.g., peroxides, oxygen, ozone), which normally manifests itself in a negative way in the working-up and drying process. This sensitivity is particularly pronounced in rubbers with unsaturated portions in the molecule chain, such as for example polybutadiene.

A particular problem in the working-up of graft rubber polymers produced by polymerisation in aqueous emulsion is accordingly to protect the rubber as soon as possible against oxidative decomposition or other oxidative damage.

Although numerous methods for stabilizing graft rubber polymers are described in the literature (see for example Gächter/Müller: Kunstoff-Additive, Carl Hanser Verlag, Munich, Vienna 1979), the disadvantages of these methods however are an insufficient protection of the polymer against oxidative reagents in the aqueous phase as well as the large addition of primary and secondary antioxidants that is accordingly necessary (as a rule sterically hindered phenols and esters of thiodipropionic acid and/or other sulfur-containing compounds), which can involve high expenditure and lead to other problems such as too high a proportion of volatile substances (emission problems) or undesirable changes in properties (e.g. lowering of the modulus of elasticity).

Accordingly, the object of the invention was furthermore to provide emulsion graft rubbers already highly stabilized in an earlier stage, using as small amounts as possible of primary antioxidants present in the form of organic compounds, and/or optionally also as small amounts as possible of correspondingly secondary antioxidants.

It has now been found that graft rubber polymers produced by emulsion polymerisation and having improved stability in the working-up and drying process are obtained by adding a stabilizer composition that contains a compound having at least one sterically hindered phenolic group and a water-soluble salt of a specific phosphorous acid in the form of aqueous preparations before the working-up stage.

ABS molding compositions are two-phase plastics consisting of a thermoplastic copolymer of resin-forming monomers, e.g. styrene and acrylonitrile, in which the styrene may be wholly or partially replaced by α-methylstyrene or methyl methacrylate, this copolymer, also termed SAN resin or matrix resin, forming the outer phase, as well as at least one graft polymer that may be obtained by polymerisation of one or more resin-forming monomers, e.g. the monomers mentioned above, in the presence of a rubber, e.g. butadiene homopolymer or copolymer (“graft base”). This graft polymer (“elastomer phase” or “graft rubber”) forms the dispersed phase in the matrix resin.

The aforementioned polymers may in principle be produced by known methods such as emulsion, solution, bulk, suspension or precipitation polymerisation, or by compositions of such processes.

In the processing of such ABS polymers undesirable odours are often produced, especially at high processing temperatures. These intrinsic odours may lead to problems in special applications of the molded parts (for example in automobile interiors).

In order to solve these problems it has been proposed inter alia to add special compositions of zinc oxide and/or magnesium oxide and epoxide group-containing compounds in the compounding stage (see EP-B 849 317).

The modulus of elasticity behavior and the emission behavior of the molding compositions may however be adversely affected by adding epoxide group-containing compounds. Zinc oxide and magnesium oxide may in addition have a negative effect on the gloss behavior.

A further object of the present invention is accordingly to produce impact modified thermoplastic molding compositions, in particular ABS polymer molding compositions, that do not exhibit any undesirable odours after they have been processed into molded parts. At the same time the other properties should not be negatively influenced.

It has now been found that this object may be achieved by thermoplastic molding compositions containing special graft rubbers as impact modifiers.

### DETAILED DESCRIPTION OF THE INVENTION

The present invention provides a stabilizing composition comprising

a) 1 to 99 parts by weight, preferably 10 to 90 parts by weight and particularly preferably 20 to 80 parts by weight of at least one antioxidant in the form of a compound having at least one sterically hindered phenol group, and

b) 99 to 1 part by weight, preferably 90 to 10 parts by weight and particularly preferably 80 to 20 parts by weight of at least one water-soluble inorganic salt of an acid selected from the group consisting of hypophosporous acid (H₃PO₂) and phosphorous acid (H₃PO₃ and HPO₂).

Suitable antioxidants according to component a) are compounds that contain at least one sterically hindered phenol group.

Examples of such compounds are 2,6-di-tert.-butyl-4-methylphenol, 2-tert.-butyl-4,6-dimethylphenol, 2,6-di-tert.-butyl-4-ethylphenol, 2,6-di-tert.-butyl-4-n-butylphenol, 2,6-di-tert.-butyl-4-isobutylphenol, 2,6-dicyclopentyl-4-methylphenol, 2-α-methylcyclohexyl)4,6-dimethylphenol, 2,6-dioctadecyl-4-methylphenol, 2,4,6-tricyclohexylphenol, 2,6-di-tert.-butyl-4-methoxymethylphenol, 2,6-dinonyl-4-methylphenol, 2,4-dimethyl-6-(1′-methylundec-1′-yl)-phenol, 2,4-dimethyl-6-(1′-methylheptadec-1′-yl)-phenol, 2,4-dimethyl-6-(1′-methyltridec-1′-yl)-phenol, 2,2′-methylene-bis-(6-tert.-butyl-4-methyl phenol), 2,2′-methylene-bis-(6-tert.-butyl-4-ethylphenol), 2,2′-methylene-bis-[4-methyl-6-α-methylcyclohexyl)-phenol], 2,2′-methylene-bis-(4-methyl-6-cyclohexylphenol), 2,2′-methylene-bis-(6-nonyl-4-methylphenol), 2,2′-methylene-bis-(4,6-di-tert.-butylphenol), 2,2′-ethylidene-bis-(4,6-di-tert.-butylphenol), 2,2′-ethylidene-bis-(6-tert.-butyl-4-isobutylphenol), 2,2′-methylene-bis-[6-(α-methylbenzyl)]-4-nonylphenol, 2,2′-methylene-bis-[6-(α,α-dimethylbenzyl)-4-nonylphenol], 4,4′-methylene-bis-(2,6-di-tert.-butylphenol), 4,4′-methylene-bis-(6-tert.-butyl-2-methylphenol), 1,1-bis-(5-tert.-butyl-4-hydroxy-2-methylphenyl)-butane, 2,6-bis-(3-tert.-butyl-5-methyl-2-hydroxybenzyl)-4-methylphenol, 1,1,3-tris-(5-tert.-butyl-4-hydroxy-2-methylphenyl)-butane, 1,1-bis-(5-tert.-butyl-4-hydroxy-2-methylphenyl)-3-n-dodecylmercaptobutane, ethylene glycol-bis-[3,3-bis-(3′-tert.-butyl-4′-hydroxyphenyl)-butyrane], bis-(3-tert.-butyl-4-hydroxy-5-methylphenyl)-dicylcopentadiene, bis-[2-(3′-tert.-butyl-2′-hydroxy-5′-methylbenzyl)-6-tert.-butyl-4-methyl phenyl]-terephthalate, 1,1-bis-(3,5-dimethyl-2-hydroxyphenyl)-butane, 2,2-bis-(3,5-di-tert.-butyl-4-hydroxyphenyl)-propane, 4,4′-butylidene-bis-(2-tert.-butyl-5-methylphenol), 2,2′-isobutylidene-bis-(4,6-dimethylphenol), 2,2-bis-(5-tert.-butyl-4-hydroxy-2-methylphenyl˜)-4-n-dodecylmercaptobutane, 1,1,5,5,-tetra-(5-tert.-butyl-4-hydroxy-2-methylphenyl)-pentane, triethylene glycol-bis-3-(3-tert.-butyl-4-hydroxy-5-methylphenyl)-propionate, esters of 3,5-di-tert.-butyl-4-hydroxyphenylacetic acid with monbhydric or polyhydric alcohols, such as for example with methanol, ethanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxy)-ethyl isocyanu rate, N,N′-bis-(hydroxyethyl)-oxalic acid diamide, 3-thiaundecanol, 3-thiopentadecanol, trimethylhexanediol, trimethylol propane, 4-hydroxymethyl-1-phospha-2,6,7-trioxabicyclo-[2.2.2]-octane, for example octadecyl-3-(3,5-d i-tert.-butyl-4-hydroxyphenyl)-propionate, 1,6-hexanediol-bis-3-(3,5-di-tert.-butyl-4-hydroxyphenyl)-propionate or tetrakis[methylene-3-(3,5-di-tert.-butyl-4-hydroxyphenyl)-propionate]-methane, mixed C₁₃₋₁₅-alkyl esters of 3,5-bis-(1,1-dimethylethyl)-4-hydroxybenzenepropionic acid, 2,2-thio-bis-(6-tert.-butyl-4-methylphenol), 2,2′-thio-bis-(4-octylphenol), 4,4′-thio-bis-(6-tert.-butyl-3-methyl phenol), 4,4′-thio-bis-(6-tert.-butyl-2-methyl phenol), 4,4′-thio-bis-(3,6-di-sec.-amylphenol), 4,4′-bis-(2,6-dimethyl-4-hydroxyphenyl)-disulfide, as well as compounds of the general formula (I) or compounds of the general formula (II)

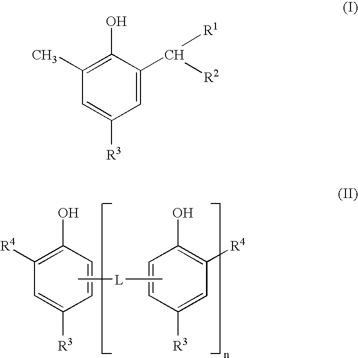

wherein

R¹=C₁-C₂-alkyl

R²=C₂-C₃₀-alkyl

R³=C₁-C₄-alkyl

R⁴=tert.-butyl, cyclohexyl

L=—CH₂—, tricyclo[5,2,1,0^{2,6}]decan-3,8-ylene and

n≧1.

as well as arbitrary mixtures thereof.

Preferred antioxidants a) are 2,2′-methylene-bis-(6-tert.-butyl-4-methylphenol), 2,2′-methylene-bis-(6-tert.-butyl-4-ethylphenol), triethylene glycol bis-3-(3-tert.-butyl-4-hydroxy-5-methylphenyl)-propionate, octadecyl-3-(3,5-di-tert.-butyl-4-hydroxyphenyl)-propionate, compound (I) where R¹=CH₃, R²=n-C₁₄H₂₉ and R³=CH₃, compound (II) where R³=CH₃, R⁴=t-C₄H₉, L tricyclo[5,2,1,0^{2,6}]decan-3,8-ylene and n<1.

Suitable water-soluble salts according to component b) are salts of hypophosphorous acid (H₃PO₂) or of phosphorous acid (H₃PO₃ and HPO₂).

In this connection “water-soluble” denotes solubility of at least 1 g of salt in 100 g of water, preferably at least 2 g of salt in 100 g of water and particularly preferably at least 5 g of salt in 100 g of water (in each case at 50° C.).

Examples of such compounds include sodium hypophosphite, potassium hypophosphite, magnesium hypophosphite, calcium hypophosphite, sodium phosphite, potassium phosphite, calcium phosphite as well as mixtures thereof.

Preferred compounds b) are sodium hypophosphite and sodium phosphite.

The stabilizing compositions according to the invention may additionally contain as component c), organic, water insoluble phosphorus-containing stabilizers such as for example triphenyl phosphite, diphenylalkyl phosphites, phenyldialkyl phosphites, tris-(nonylphenyl)-phosphite, trilauryl phosphite, trioctadecyl phosphite, distearyl pentaerythritol phosphite, tris-(2,4-di-tert.-butylphenyl)-phosphite, diisodecylpenta-erythritol diphosphite, bis-(2,4-di-tert.-butylphenyl)-pentaerythritol diphosphite, bis-(2,6-di-tert.-butyl-4-methylphenyl)-pentaerythritol diphosphite, bis-isodecyloxypenta-erythritol diphosphite, bis-(2,4-di-tert.-butyl-6-methylphenyl)-pentaerythritol diphosphite, bis-(2,4,6-tri-tert.-butyl phenyl)-pentaerythritol d iphosphite, tristearyl-sorbitol triphosphite, tetrakis-(2,4-di-tert.-butylphenyl)-4,4′-biphenylene diphosphonite, 6-isooctyloxy-2,4,8,10-tetra-tert.-butyl-12H-d ibenz[d,g]-1,3,2-dioxaphosphocine, 6-fluoro-2,4,8, 10-tetra-tert.-butyl-12-methyldibenz[d,g]-1,3,2-dioxaphosphocine, bis-(2,4-di-tert.-butyl-6-methylphenyl)-methyl phosphite, bis-(2,4-di-tert.-butyl-6-methylphenyl)-ethyl phosphite as well as mixtures thereof in an amount of up to 50 parts by weight referred to 100 parts by weight of a)+b).

Preferred compounds c) are tris-(2,4-di-tert.-butylphenyl)-phosphite, bis-(2,4-di-tert.-butylphenyl)-pentaerythritol diphosphite and tris-(nonylphenyl)-phosphite.

Furthermore the stabilizing compositions according to the invention may contain as sulfur-containing component d), sulfur-containing stabilizers such as for example esters of β-thiodipropionic acid (e.g. dilauryl thiodipropionate, distearyl thiodipropionate, dimyristyl thiodipropionate, tridecyl thiodipropionate), mercaptobenzimidazole, the zinc salt of 2-mercaptobenzimidazole, dioctadecyl disulfide, pentaerythritol tetrakis-(β-dodecylmercapto)-propionate, compounds obtained by polymerisation of vinyl monomers such as for example styrene, acrylonitrile, methyl methacrylate in the presence of mercaptans (see for example EP-PS 195 918), as well as mixtures thereof in an amount of up to 50 parts by weight referred to 100 parts by weight of a)+b). Preferred compounds d) are dilauryl thiodipropionate, distearyl thiodipropionate and compounds obtained by polymerisation of vinyl monomers such as for example styrene, acrylonitrile, methyl methacrylate in the presence of mercaptans.

The stabilizing compositions according to the invention are suitable as agents for stabilizing polymers, in particular polymers produced in aqueous dispersion such as for example aqueous emulsion (emulsion polymerisation) or aqueous suspension (suspension polymerisation), against oxidative decomposition or other changes brought about by the action of oxygen.

The present invention accordingly also provides for the use of the stabilizing compositions according to the invention for stabilizing polymers.

Polymers that may be stabilized by the addition of the mixtures according to the invention are for example acrylonitrile-butadiene-styrene terpolymers (ABS), methyl methacrylate-butadiene-styrene terpolymers (MBS), styrene-acrylonitrile copolymers (SAN), α-methylstyrene-acrylonitrile copolymers, polystyrene, impact resistant polystyrene (HIPS), polymethyl methacrylate, polybutadiene, styrene-butadiene rubbers, acrylonitrile-butadiene rubbers, polychloroprene, polyisoprene, acrylate rubbers, ethylene-vinyl acetate rubbers, vinylpyridine-butadiene rubbers, vinylpyridine-styrene-butadiene rubbers, vinylpyridine-acrylonitrile-butadiene rubbers as well as carboxylated rubbers.

The mixtures according to the invention are particularly effective in stabilizing ABS polymers, MBS polymers and rubber polymers.

The present invention also provides a process for stabilizing polymers, characterized in that a stabilizing composition containing

a) 1 to 99 parts by weight, preferably 10 to 90 parts by weight and particularly preferably 20 to 80 parts by weight of at least one antioxidant in the form of a compound having at least one sterically hindered phenol group, and

b) 99 to 1 part by weight, preferably 90 to 10 parts by weight and particularly preferably 80 to 20 parts by weight of at least one water-soluble inorganic salt of an acid selected from the group consisting of hypophosporous acid (H₃PO₂) and phosphorous acid (H₃PO₃ and HPO₂)

or the individual components of this stabilizing composition together or individually in the form of an aqueous solution or an aqueous dispersion or an aqueous emulsion or a combination of any of these aqueous forms, is added to the polymer material present in aqueous emulsion or aqueous suspension, followed by working-up according to conventional methods.

Conventional working-up methods include for example precipitation of the emulsion polymers by adding electrolytes such as for example salts or acids, or by vigorous cooling, spray drying of the emulsion, or separation of the polymer by filtration or centrifugation in the case of suspension polymers.

The amounts of the stabilizing compositions according to the invention used for the stabilization are 0.1 to 10 parts by weight, preferably 0.2 to 8 parts by weight and particularly preferably 0.5 to 5 parts by weight referred to 100 parts by weight of polymer to be stabilized.

The present invention furthermore provides stabilized polymer materials that may be obtained by a process that involves adding, before the working-up, 0.1 to 10 parts by weight, preferably 0.2 to 8 parts by weight and particularly preferably 0.5 to 5 parts by weight (in each case referred to 100 parts by weight of polymer) of a stabilizing composition containing

a) 1 to 99 parts by weight, preferably 10 to 90 parts by weight and particularly preferably 20 to 80 parts by weight of at least one antioxidant in the form of a compound having at least one sterically hindered phenol group, and

b) 99 to 1 part by weight, preferably 90 to 10 parts by weight and particularly preferably 80 to 20 parts by weight of at least one water-soluble inorganic salt of an acid selected from the group consisting of hypophosporous acid (H₃PO₂) and phosphorous acid (H₃PO₃ and HPO₂).

In this connection the stabilizer mixture is added in the form of an aqueous solution or an aqueous dispersion or an aqueous emulsion or a combination of these aqueous forms to the polymer material to be stabilized that is present in the aqueous emulsion or aqueous suspension. It is also possible to add the individual constituents of the stabilizer mixture in different aqueous forms to the polymer.

Preferably the stabilized polymer materials obtainable by the process according to the invention are graft rubber polymers produced by emulsion polymerisation and containing

I) at least one rubber having a glass transition temperature <10° C. as graft base, and

II) at least one grafted phase that is the product of the polymerisation of at least one vinyl monomer in the presence of the rubber.

Suitable rubbers 1) are rubbers present in emulsion form having glass transition temperatures ≦10° C. Examples of such rubbers include polymers of butadiene, for example polybutadiene, butadiene-styrene copolymers, preferably with styrene contents of 3 to 40 wt. %, butadiene-acrylonitrile copolymers, preferably with acrylonitrile contents of 3 to 20 wt. %, terpolymers of butadiene, styrene and acrylonitrile, copolymers and terpolymers of butadiene with other vinyl monomers such as for example acrylic acid, methacrylic acid, vinylpyridine, C₁₋₈-acrylic acid esters such as for example n-butyl acrylate or 2-ethylhexyl acrylate, C₁₋₈-methacrylic acid esters such as for example methyl methacrylate, as well as homopolymers and copolymers of C₁₋₈-alkyl acrylates such as for example poly-n-butyl acrylate.

Preferred rubbers 1) are polybutadiene, butadiene-styrene copolymers, butadiene-acrylonitrile copolymers.

Particularly preferred are polybutadiene and butadiene-styrene copolymers.

For the production of the graft rubber polymers according to the invention, the rubber is conveniently present in emulsion form. The rubber latices used for the production of the graft rubber polymers have mean particle diameters of 50 to 1000 nm, preferably 80 to 800 nm and particularly preferably 100 to 600 nm. In this connection monomodal, bimodal, trimodal and multimodal rubber latices may be used.

Suitable vinyl monomers for the construction of the grafted phase II) are monomers that may be polymerized in aqueous emulsion in the presence of a rubber latex. Examples of such monomers are vinyl aromatic compounds such as for example styrene or a-methylstyrene, unsaturated nitriles such as for example acrylonitrile or methacrylonitrile, C₁₋₈-acrylic acid esters and C₁₋₈-methacrylic acid esters such as for example n-butyl acrylate, tert.-butyl acrylate or methyl methacrylate, as well as N-substituted maleimides such as for example N-phenylmaleimide.

Particularly suitable are monomer mixtures such as for example styrene/acrylonitrile mixtures, styrene/methyl methacrylate mixtures, styrene/acrylonitrile/methyl methacrylate mixtures, styrene/acrylonitrile/N-phenylmaleimide mixtures. Particularly preferred vinyl monomers are styrene, acrylonitrile as well as mixtures thereof.

The graft rubber polymers according to the invention have a rubber content of 10 to 90 wt. %, preferably 30 to 80 wt. % and particularly preferably 40 to 75 wt. % referred to I) and II).

The graft rubber polymers according to the invention are characterized by an improved stability in the working-up and drying process. Even minor total amounts of organic stabilizers are sufficient to achieve the improved thermal stabilities in the product.

The graft rubber polymers according to the invention are suitable for example as impact modifiers for thermoplastic resins. Examples of such thermoplastic resins include polyvinyl chloride, polymethyl methacrylate, styrene/acrylonitrile copolymers, α-methylstyrene/acrylonitrile copolymers, polyamides, polyethylene terephthalates, polybutylene terephthalates, aromatic polycarbonates, aromatic polyester carbonates as well as combinations selected from these thermoplastic resins.

The present invention accordingly also provides thermoplastic molding compositions containing

A) at least one graft rubber produced by free-radical emulsion polymerisation of at least one vinyl monomer, preferably styrene and acrylonitrile, in a weight ratio of 90:10 to 50:50, in which styrene and/or acrylonitrile may be wholly or partially replaced by α-methylstyrene, methyl methacrylate or N-phenylmaleimide, particularly preferably the polymerisation of styrene and acrylonitrile in the presence of at least one rubber present in latex form with a glass transition temperature below 0° C., preferably a butadiene rubber present in latex form, particularly preferably polybutadiene, to which was added, before the working-up, a stabilizing composition of

a) at least one antioxidant in the form of a compound having at least one sterically hindered phenol group, and

b) at least one water-soluble inorganic salt of an acid selected from the group consisting of hypophosphorous acid (H₃PO₂) and phosphorous acid (H₃PO₃ or HPO₂) in the form of an aqueous solution or dispersion, and

B) at least one thermoplastic rubber-free polymer obtained by polymerisation of at least one resin-forming vinyl monomer, preferably styrene and acrylonitrile, in a weight ratio of 90:10 to 50:50, in which styrene and/or acrylonitrile may be wholly or partially replaced by α-methylstyrene, methyl methacrylate or N-phenylmaleimide.

In general the molding compositions according to the invention may contain the graft rubber A) and the thermoplastic rubber-free vinyl polymer B) in any amounts, typically in the range 5 to 95 parts by weight of A) and 95 to 5 parts by weight of B), preferably 10 to 60 parts by weight of A) and 90 to 40 parts by weight of B), and particularly preferably 15 to 50 parts by weight of A) and 85 to 50 parts by weight of B).

Furthermore-the molding compositions according to the invention may contain further rubber-free thermoplastic resins that are not built up from vinyl monomers, in amounts of up to 1000 parts by weight, preferably up to 700 parts by weight and particularly preferably up to 500 parts by weight (in each case referred to 100 parts by weight of A+B).

For the production of the graft rubber A), 20 to 70 parts by weight, particularly preferably 25 to 60 parts by weight, of at least one vinyl monomer, preferably a mixture of styrene and acrylonitrile, in which styrene and/or acrylonitrile may be wholly or partially replaced by α-methylstyrene, methyl methacrylate or N-phenylmaleimide, are polymerised in the presence of preferably 30 to 80 parts by weight, particularly preferably 40 to 75 parts by weight (in each case referred to solids) of a rubber latex.

The monomers used in these graft polymers are preferably mixtures of styrene and acrylonitrile in a weight ratio of 90:10 to 50:50, particularly preferably in a weight ratio of 80:20 to 65:35.

Suitable rubber present in latex form for the production of the graft rubbers A) are in principle all rubber polymers with a glass transition temperature below 0° C.

Examples of such rubber polymers are polydienes such as for example polybutadiene and polyisoprene, alkyl acrylate rubbers based on C₁₋₈-alkyl acrylates such as for example poly-n-butyl acrylate, polysiloxane rubbers such as for example products based on polydimethylsiloxane.

Preferred rubbers for the production of the graft rubbers A) are butadiene polymer latices, which may be produced by emulsion polymerisation of butadiene and optionally comonomers. This polymerisation process is known and is described for example in Houben-Weyl, Methoden der Organischen Chemie, Makromolekulare Stoffe, Part 1, p. 674 (1961), ThiemeVerlag Stuttgart.

As comonomers there may be used up to 50 wt. % (referred to the total amount of monomer used for the butadiene polymer production) of one or more monomers copolymerisable with butadiene. Preferred examples of such monomers are isoprene, chloroprene, acrylonitrile, styrene, α-methylstyrene, C₁-C₄-alkylstyrenes, C₁-C₈-alkyl acrylates, C₁-C₈-alkyl methacrylates, alkylene glycol diacrylates, alkylene glycol dimethacrylates and divinylbenzene. Butadiene alone is preferably used.

The rubber used for the production of the graft rubber A) may be present in the form of a latex with a monomodal, bimodal, trimodal or multimodal particle size distribution. Preferred are rubber latices that have a monomodal, bimodal or trimodal particle size distribution.

The mean particle diameters (d₅₀ value) of the monomodal, bimodal, trimodal or multimodal rubber latices used for the production of the graft rubbers A) may vary within wide ranges. Suitable mean particle diameters are for example between 50 and 600 nm, preferably between 80 and 550 nm and particularly preferably between 100 and 500 nm.

For the production of rubber latices with bimodal, trimodal or multimodal particle size distributions, preferably monomodal rubber latices of different mean particle size and narrow particle size distribution are mixed with one another.

Monomodal rubber latices with a narrow particle size distribution are understood within the context of the invention to mean those latices that have a particle size distribution width (measured as d₉₀-d₁₀ from the integral particle size distribution) of 30 to 150 nm, preferably 35 to 100 nm and particularly preferably 40 to 80 nm.

Monomodal rubber latices with a narrow particle size distribution are preferably produced by emulsion polymerisation of suitable monomers, preferably monomer mixtures containing butadiene, particularly preferably butadiene per se, according to the so-called seed polymerisation technique, in which first of all a finely particulate polymer, preferably a rubber polymer, particularly preferably a butadiene polymer, is produced as seed latex and is then polymerised further by further conversion with rubber-forming monomers, preferably with monomers containing butadiene, to form larger particles (see for example Houben-Weyl, Methoden der Organischen Chemie, Makromolekulare Stoffe Part 1, p. 339 (1961), Thieme Verlag Stuttgart).

In this connection the seed batch process or the seed feed process is preferably used.

It is also possible in the production of the rubber latices to produce first of all a finely particulate butadiene polymer by known methods and then agglomerate the latter in a known manner in order to adjust the necessary particle size. Relevant techniques are described for example in EP-A 0 029 613; EP-A 0 007 810; DD-A 144 415; DE-A 1 233 131; DE-A 1 258 076; DE-A 2 101 650; GB-A 1 379 391.

In principle the rubber latices may also be produced by emulsifying finely particulate rubber polymers in aqueous media (see for example, JP-A 55-125 102).

The differences between the mean particle diameters (d₅₀ value from the integral particle size distribution) of the rubber latices used for the mixture in the preferred production of bimodal, trimodal or multimodal particle size distributions are at least 30 nm, preferably at least 60 nm and particularly preferably at least 80 nm.

The gel contents of the rubber latices used for the production of the graft rubbers A) are not critical and may vary within wide ranges. Normally the values are between ca. 30% and 98%, preferably between 40% and 95%.

The gel contents of the rubber latices may in principle be adjusted in a known manner by using suitable reaction conditions (e.g., high reaction temperature and/or polymerisation up to a high conversion, as well as optionally addition of crosslinking substances in order to achieve a high gel content, or for example low reaction temperature and/or termination of the polymerisation reaction before crosslinking has proceeded too far, as well as optionally the addition of molecular weight regulators such as for example n-dodecylmercaptan or t-dodecylmercaptan in order to achieve a low gel content).

As emulsifiers there may be used conventional anionic emulsifiers such as alkyl sulfates, alkyl sulfonates, aralkyl sulfonates, soaps of saturated or unsaturated fatty acids, as well as alkaline disproportionated or hydrogenated abietic acid or tall oil acid; emulsifiers with carboxyl groups are preferably used (e.g. salts of C₁₀-C₁₈-fatty acids, disproportionated abietic acid, hydrogenated abietic acid, emulsifiers according to DE-A 3 639 904 and DE-A 3 913 509).

The determination of the mean particle diameter d₅₀ as well as the d₁₀ and d₉₀ values may be carried out by ultracentrifuge measurements (see W. Scholtan, H. Lange: Kolloid Z. u. Z. Polymere 250, pp. 782 to 796 (1972)).

The specified values for the gel content refer to the determination according to the wire cage method in toluene (see Houben-Weyl, Methoden der Organischen Chemie, Makromolekulare Stoffe, Part 1, p. 307 (1961), Thieme Verlag Stuttgart).

The graft polymerisation in the production of the graft rubbers A) may be carried out so that the monomer mixture is added in portions or continuously to the rubber latex and then polymerised. In this connection special monomer-rubber ratios are preferably maintained.

The graft polymerisation to produce the graft rubber A) may for example be carried out by adding the monomer in such a way that within the first half of the overall monomer addition time 55 to 90 wt. %, preferably 60 to 80 wt. % and particularly preferably 65 to 75 wt. % of the total monomers to be used in the graft polymerisation are metered in, the remaining portion of the monomers being metered in within the second half of the overall monomer addition time. A uniform continuous metering in of the monomers to the rubber latex is preferred.

Molecular weight regulators may in addition be used in the graft polymerisation, preferably in amounts of 0.05 to 2 wt. %, particularly preferably in amounts of 0.1 to 1 wt. % (in each case referred to the total amount of monomers in the graft polymerisation stage). Suitable molecular weight regulators are for example alkylmercaptans such as n-dodecylmercaptan, t-dodecylmercaptan, as well as dimeric α-methylstyrene or terpinolene.

Suitable initiators for the production of the graft rubber A) according to the invention include inorganic and organic peroxides, for example H₂O₂, di-tert.-butyl peroxide, cumene hydroperoxide, dicyclohexyl percarbonate, tert.-butyl hydroperoxide, p-menthane hydroperoxide, azo initiators such as azobisisobutyronitrile, inorganic per salts such as ammonium, sodium or potassium persulfate, potassium perphosphate, sodium perborate as well as redox systems. Redox systems consist as a rule of an organic oxidizing agent and a reducing agent, in which connection heavy metal ions may additionally be present in the reaction medium (see Houben-Weyl, Methoden der Organischen Chemie, Vol. 14/1, pp. 263 to 297).

The polymerisation temperature is generally 25° C. to 160° C., preferably 40° C. to 90° C. The graft polymerisation may be carried out under normal temperature conditions, for example isothermally; however the graft polymerisation is preferably carried out so that the temperature difference between the start and end of the reaction is at least 10° C., preferably at least 15° C. and particularly preferably 20° C.

Suitable emulsifiers are for example conventional anionic emulsifiers such as alkyl sulfates, alkyl sulfonates, aralkyl sulfonates, soaps of saturated or unsaturated fatty acids, as well as alkaline disproportionated or hydrogenated abietic or tall oil acids. Emulsifiers with carboxyl groups are preferably employed (for example salts of C₁₀₋₁₈-fatty acids, disproportionated abietic acid, hydrogenated abietic acid, emulsifiers according to DE-A 3 639 904 and DE-A 3 913 509).

In the production of the graft rubbers A), there is preferably added to the graft rubber emulsion before the working-up, a stabilizing composition containing

a) at least one antioxidant in the form of a compound containing in its molecular structure at least one sterically hindered phenol group, and

b) at least one water-soluble inorganic salt of an acid selected from the group consisting of hypophosphorous acid (H₃PO₂) and phosphorous acid (H₃PO₃ and HPO₂)

as described above, in the form of an aqueous solution or dispersion.

The amount of the stabilizing composition of a) and b) is usually 0.1 to 10 parts by weight, preferably 0.2 to 8 parts by weight and particularly preferably 0.5 to 5 parts by weight (in each case referred to 100 parts by weight of graft rubber to be stabilized).

The amounts of the compounds c) that are optionally additionally used are normally 0.1 to 5 parts by weight, preferably 0.2 to 3 parts by weight and particularly preferably 0.4 to 2 parts by weight (in each case referred to 100 parts by weight of graft rubber to be stabilized).

The amounts of the compounds d) that are optionally additionally used are normally 0.2 to 7 parts by weight, preferably 0.3 to 6 parts by weight and particularly preferably 0.4 to 5 parts by weight (in each case referred to 100 parts by weight of graft rubber to be stabilized).

The addition of the components a) and b) and optionally in addition c) and/or d) added before the working-up takes place in the form of aqueous preparations, in which connection aqueous solutions, aqueous dispersions, aqueous emulsions, aqueous suspensions or combinations of the aforementioned aqueous systems may be used. The addition of the compounds may take place jointly or individually in the form of the aforementioned aqueous systems.

Preferably no sulfur-containing compound is added to the graft rubber emulsion before the working-up.

As rubber-free copolymers B) there are preferably used copolymers of styrene and acrylonitrile in a weight ratio of 95:5 to 50:50, in which styrene and/or acrylonitrile may be wholly or partially replaced by α-methylstyrene, methyl methacrylate or N-phenylmaleimide.

Particularly preferred are those copolymers B) whose acrylonitrile proportion is less than 30 wt. %.

The copolymers preferably have weight average molecular weights (\overline{M}_{w}) of 20,000 to 200,000 and intrinsic viscosities [η] of 20 to 110 ml/g (measured in dimethylformamide at 25° C.).

Details of the production of these resins are described for example in DE-A 24 20 358 and DE-A 27 24 360. Vinyl resins produced by bulk polymerisation or solution polymerisation have proved particularly suitable. The copolymers may be added alone or in an arbitrary mixture.

In addition to the thermoplastic resins built up from vinyl monomers, it is also possible to use polycondensates, for example aromatic polycarbonates, aromatic polyester carbonates, polyesters, polyamides as rubber-free copolymer in the molding compositions according to the invention.

Suitable thermoplastic polycarbonates and polyester carbonates are known (see for example DE-A 14 95 626, DE-A 22 32 877, DE-A 27 03 376, DE-A 27 14 544, DE-A 30 00 610, DE-A 38 32 396, DE-A 30 77 934), which may be produced for example by reacting diphenols of the formulae (III) and (IV)

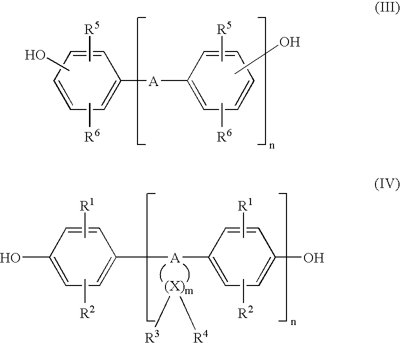

wherein

A denotes a single bond, C₁-C₅-alkylene, C₂-C₅-alkylidene, C₅-C₆-cycloalkylidene, —O—, —S—, —SO—, —SO₂— or —CO—,

R⁵ and R⁶ independently of one another denote hydrogen, methyl or halogen, in particular hydrogen, methyl, chlorine or bromine,

R¹ and R² independently of one another denote hydrogen, halogen, preferably chlorine or bromine, C₁-C₈-alkyl, preferably methyl, ethyl, C₅-C₆-cycloalkyl, preferably cyclohexyl, C₆-C₁₀-aryl, preferably phenyl, or C₇-C₁₂-aralkyl, preferably phenyl-C₁-C₄-alkyl, in particular benzyl,

m is an integer from 4 to 7, and is preferably 4 or 5,

n is 0 or 1,

R³ and R⁴ may be chosen individually for each X and independently of one another denote hydrogen or C₁-C₆-alkyl, and

X denotes carbon,

with carbonic acid halides, preferably phosgene, and/or with aromatic dicarboxylic acid dihalides, preferably benzenedicarboxylic acid dihalides, by phase interface polycondensation or with phosgene by polycondensation in homogeneous phase (the so-called pyridine process), wherein the molecular weight may be adjusted in a known manner by an appropriate amount of known chain terminators.

Suitable diphenols of the formulae (III) and (IV) include for example hydroquinone, resorcinol, 4,4′-dihydroxydiphenyl, 2,2-bis-(4-hydroxyphenyl)-propane, 2,4-bis-(4-hydroxyphenyl)-2-methylbutane, 2,2-bis-(4-hydroxy-3,5-dimethylphenyl)-propane, 2,2-bis-(4-hydroxy-3,5-dichlorophenyl)-propane, 2,2-bis-(4-hydroxy-3,5-dibromophenyl)-propane, 1,1-bis-(4-hydroxyphenyl)-cyclohexane, 1,1-bis-(4-hydroxyphenyl)-3,3,5-tri-methylcyclohexane, 1,1-bis-(4-hydroxyphenyl)-3,3-dimethylcyclohexane, 1,1-bis-(4-hydroxyphenyl)-3,3,5,5-tetramethylcyclohexane or 1,1-bis-(4-hydroxyphenyl)-2,4,4-trimethylcyclopentane.

Preferred diphenols of the formula (III) are 2,2-bis-(4-hydroxyphenyl)-propane and 1,1-bis-(4-hydroxyphenyl)-cyclohexane; the preferred phenol of the formula (IV) is 1,1-bis-(4-hydroxyphenyl)-3,35-trimethylcyclohexane.

Mixtures of diphenols may also be used.

Suitable chain terminators include for example phenol, p-tert.-butylphenol, long-chain alkylphenols such as 4-(1,3-tetramethylbutyl)-phenol according to DE-A 2 842 005, monoalkylphenols, dialkylphenols with a total of 8 to 20 C atoms in the alkyl substituents according to DE-A 3 506 472, such as p-nonylphenol, 2,5-di-tert.-butylphenol, p-tert.-octylphenol, p-dodecylphenol, 2-(3,5-dimethylheptyl)-phenol and 4-(3,5-dimethylheptyl)-phenol. The necessary amount of chain terminators is in general 0.5 to 10 mole %, referred to the sum of the diphenols (III) and (IV).

The suitable polycarbonates and/or polyester carbonates may be linear or branched; branched products are preferably obtained by incorporating 0.05 to 2.0 mole %, referred to the sum total of diphenols employed, of trifunctional or higher functional compounds, for example those with three or more than three phenolic OH groups.

The suitable polycarbonates and/or polyester carbonates may contain aromatically bound halogen, preferably bromine and/or chlorine; however, they are preferably halogen-free.

The polycarbonates/polyester carbonates have mean molecular weights (\overline{M}w, weight average) determined for example by ultra-centrifugation or light scattering measurements, of 10,000 to 200,000, preferably 20,000 to 80,000.

Suitable thermoplastic polyesters are preferably polyalkylene terephthalates, i.e. reaction products of aromatic dicarboxylic acids or their reactive derivatives (for example dimethyl esters or anhydrides) and aliphatic, cycloaliphatic or arylaliphatic diols and mixtures of such reaction products.

Preferred polyalkylene terephthalates may be produced from terephthalic acids (or their reactive derivatives) and aliphatic or cycloaliphatic diols containing 2 to 10 C atoms according to known methods (Kunstoff-Handbuch, Vol. VIII, p. 695 ff, Carl Hanser Verlag, Munich 1973).

In preferred polyalkylene terephthalates 80 to 100 mole %, preferably 90 to 100 mole % of the dicarboxylic acid radicals are terephthalic acid radicals, and 80 to 100 mole %, preferably 90 to 100 mole % of the diol radicals are ethylene glycol and/or butanediol-1,4 radicals.

The preferred polyalkylene terephthalates may in addition to ethylene glycol radicals and/or butanediol-1,4 radicals also contain 0 to 20 mole % of radicals of other aliphatic diols with 3 to 12 C atoms or cycloaliphatic diols with 6 to 12 C atoms, for example radicals of propanediol-1,3,2-ethylpropanediol-1,3, neopentyl glycol, pentanediol-1,5, hexanediol-1,6, cyclohexanedimethanol-1,4,3-methylpentanediol-1,3 and -1,6,2-ethylhexanediol-1,3, 2,2-diethylpropanediol-1,3, hexanediol-2,5,1,4-di(β-hydroxyethoxy)-benzene, 2,2-bis-(4-hydroxycyclohexyl)-propane, 2,4-dihydroxy-1,1,3,3-tetramethylcyclobutane, 2,2-bis-(3-β-hydroxyethoxyphenyl)-propane and 2,2-bis-(4-hydroxypropoxyphenyl)-propane (DE-A 24 07 647, 24 07 776, 27 15 932).

The polyalkylene terephthalates may be branched by the incorporation of relatively small amounts of trihydric or tetrahydric alcohols or tribasic or tetrabasic carboxylic acids, such as are described in DE-A 1 900 270 and U.S. Pat. No. 3,692,744. Examples of preferred branching agents include trimesic acid, trimellitic acid, trimethylolethane and trimethylolpropane, and pentaerythritol. It is advisable to use not more than 1 mole % of the branching agent referred to the acid component.

Particularly preferred are polyalkylene terephthalates that have been produced solely from terephthalic acid and its reactive derivatives (e.g. the dialkyl esters) and ethylene glycol and/or butanediol-1,4, and mixtures of these polyalkylene terephthalates.

Preferred polyalkylene terephthalates are also copolyesters that are produced from at least two of the alcohol components mentioned above; particularly preferred copolyesters are poly-(ethylene glycol butanediol-1,4)-terephthalates.

The preferably suitable polyalkylene terephthalates generally have an intrinsic viscosity of 0.4 to 1.5 dl/g, preferably 0.5 to 1.3 dl/g, in particular 0.6 to 1.2 dl/g, in each case measured in phenol/o-dichlorobenzene (1:1 parts by weight) at 25° C.

Suitable polyamides are known homopolyamides, copolyamides and mixtures of these polyamides. These may be partially crystalline and/or amorphous polyamides.

Suitable as partially crystalline polyamides are polyamide-6, polyamide-6,6, mixtures and corresponding copolymers of these components. Also suitable are partially crystalline polyamides whose acidic component consists wholly or partially of terephthalic acid and/or isophthalic acid and/or suberic acid and/or sebacic acid and/or azelaic acid and/or adipic acid and/or cyclohexanedicarboxylic acid, whose diamine component consists wholly or partially of m- and/or p-xylylenediamine and/or hexamethylenediamine and/or 2,2,4-trimethylhexamethylenediamine and/or 2,2,4-trimethylhexamethylenediamine and/or isophorone diamine, and whose composition is in principle known.

There should also be mentioned polyamides that are produced wholly or in part from lactams containing 7 to 12 C atoms in the ring, optionally with the co-use of one or more of the starting components mentioned above.

Particularly preferred partially crystalline polyamides are polyamide-6 and polyamide-6,6 and their mixtures. Known products may be used as amorphous polyamides. These are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis-(4-aminocyclohexyl)-methane, bis-(4-aminocyclohexyl)-propane, 3,3′-dimethyl-4,4′-diaminodicyclohexylmethane, 3-aminomethyl-3,5,5-trimethylcyclohexylamine, 2,5- and/or 2,6-bis-(aminomethyl)-norbornane and/or 1,4-diaminomethylcyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers that are obtained by polycondensation of several monomers, as well as copolymers that are produced by the addition of aminocarboxylic acids such as ε-aminocaproic acid, ω-undecanoic acid or ω-aminolauric acid or their lactams.

Particularly suitable amorphous polyamides are the polyamides produced from isophthalic acid, hexamethylenediamine and further diamines such as 4,4′-diaminodicyclohexylmethane, isophorone diamine, 2,2,4- and/or 2,4,4-trimethylhexamethylenediamine, 2,5- and/or 2,6-bis(aminomethyl)-norbornene; or from isophthalic acid, 4,4′-diaminodicyclohexylmethane and ε-caprolactam; or from isophthalic acid, 3,3′-dimethyl-4,4′-diaminodicyclohexylmethane and laurinlactam; or from terephthalic acid and the isomeric mixture of 2,2,4- and/or 2,4,4-trimethylhexamethylenediamine.

Instead of pure 4,4′-diaminodicyclohexylmethane there may also be used mixtures of the position isomeric diaminodicyclohexylmethanes that are composed of

70 to 99 mole % of the 4,4′-diamino isomer

10 to 30 mole % of the 2,4′-diamino isomer

0 to 2 mole % of the 2,2′-diamino isomer, and

optionally suitably higher condensed diamines that are obtained by hydrogenation of industrial quality diaminodiphenylmethane. Up to 30% of the isophthalic acid may be replaced by terephthalic acid.

The polyamides preferably have a relative viscosity (measured in a 1 wt. % solution in m-cresol at 25° C.) of 2.0 to 5.0, particularly preferably of 2.5 to 4.0.

The production of the molding compositions according to the invention is carried out by mixing the components A) and B) as well as optionally further constituents in conventional mixing units (preferably on multiroll stands or in mixer-extruders or internal kneaders).

The present invention accordingly also provides a process for the production of the molding compositions according to the invention, in which the components A) and B) and optionally further constituents are mixed, compounded at elevated temperature, in general at temperatures from 150° to 300° C., and extruded.

The necessary or expedient additional additives, e.g. UV stabilizers, antistatics, lubricants, mold release agents, flameproofing agents, fillers or reinforcing agents (glass fibres, carbon fibres, etc.) and colorants may be added to the molding compositions according to the invention during production, working-up, further processing and final processing.

The final processing may be undertaken in commercially available processing units and includes for example injection molding processing, panel extrusion optionally followed by heat forming, cold forming, extrusion of pipes and profiled sections, or calendar processing.

The present invention furthermore provides for the use of the molding compositions according to the invention for the production of molded parts as well as the molded parts per se.

### EXAMPLES

The invention is described in more detail in the following examples. The specified parts are always parts by weight and refer in each case to solid constituents and/or polymerizable constituents.

### Examples Relating to the Thermal Stability of Stabilized Polymers

The stability was determined by measuring the temperature (Tm) at which the exothermic reaction exhibits a maximum, by means of differential scanning calorimetry (DSC).

All DSC measurements were carried out using a DSC-2 calorimeter from Perkin-Elmer (oxygen as rinsing gas, oxygen flow rate of 60 ml/min). The heating rate in the dynamic measurement was constant at 20 K/min.

The following were used as polymers:

Polymer I (graft rubber obtained by polymerisation of 41 parts by weight of a styrene/acrylonitrile=73:27 mixture in the presence of 59 parts by weight of a polybutadiene latex),

Polymer II (polybutadiene produced by emulsion polymerisation) and

Polymer III (butadiene/acrylonitrile=64:36 polymer produced by emulsion polymerisation of a corresponding butadiene/acrylonitrile mixture.

The following substances were used in carrying out the tests described hereinafter:

A) octadecyl-3-(3,5-di-tert.-butyl-4-hydroxyphenyl)-propionate (Irganoxe 1076 from Ciba, Basel,. Switzerland)

B-1) sodium hypophosphite

B-2) sodium phosphite

The incorporation of the stabilizers or stabilizer compositions specified in Table 1 was performed by adding the stabilizer components present in aqueous solution or aqueous dispersion (Irganoxe 1076 as 25% aqueous dispersion obtained by dispersing the sodium salt of disproportionated abietic acid, sodium hypophosphite and sodium phosphite as 10% aqueous solution) to the polymers present in emulsion form.

The working-up was performed by coagulation with a magnesium sulfate/acetic acid=1:1 mixture in the form of a 1% aqueous solution, washing with water and drying at 40° C. in vacuo.

TABLE 1

| | | Stabilizer (parts by | Thermal Stability in |
|---|---|---|---|
| | | weight per 100 parts | DSC Measurement |
| Example | Polymer | by weight of polymer) | Tₘ (min) |
| 1 | I | 1 A + 1 B − 1 | 229 |
| 2 | I | 1 A + 1 B − 2 | 231 |
| 3 (Comparison) | I | 1 A | 226 |
| 4 (Comparison) | I | 1 B − 1 | 204 |
| 5 (Comparison) | I | — | 204 |
| 6 | II | 1 A + 1 B − 1 | 215 |
| 7 (Comparison) | II | 1 A | 201 |
| 8 (Comparison) | II | 1 B − 1 | 190 |
| 9 (Comparison) | II | — | 195 |
| 10 | III | 1 A + 1 B − 1 | 268 |
| 11 (Comparison) | III | 1 A | 260 |
| 12 (Comparison) | III | 1 B − 1 | 214 |
| 13 (Comparison) | III | — | 212 |

From the results shown in Table 1 it is evident that the incorporation of the stabilizer compositions according to the invention in polymers lead to a significantly improved thermal stability thereof. This is particularly surprising since the use of the components B-1 and B-2 per se did not exhibit any stabilizing effect.

### Examples Relating to the Thermal Stability of Stabilized Graft Rubbers

The following substances were used in carrying out the tests described hereinbelow:

As graft rubber there was used a mixture consisting of a first graft rubber latex I (obtained by polymerisation of 50 parts by weight of a styrene/acrylonitrile mixture (73:27) in the presence of 50 parts by weight of a polybutadiene latex with a mean particle size d₅₀ of 125 nm) and a second graft rubber latex II (obtained by polymerisation of 41 parts by weight of a styrene/acrylonitrile mixture (73:27) in the presence of 59 parts by weight of a polybutadiene latex with a mean particle size d₅₀ of 345 nm), the weight ratio of graft rubber I to graft rubber II being 1:1.

The following stabilizers were added to the graft rubber in the amounts given in Table 2:

A) octadecyl-3-(3,5-d i-tert.-butyl-4-hydroxyphenyl)-propionate (Irganox® 1076 from Ciba, Basel, Switzerland)

B) sodium hypophosphite

C) tris-(2,4-di-tert.-butylphenyl)-phosphite (Irgafose 168 from Ciba, Basel, Switzerland)

D-1) dilauryl thiodipropionate (Irganoxe PS 800 from Ciba, Basel, Switzerland)

D-2) sulfur-containing polymer of styrene, acrylonitrile and tert.-dodecylmercaptan, present in latex form.

The preparation of D-2 followed the following procedure: 3.06 parts of styrene, 1.19 parts of acrylonitrile and 0.75 parts of tert.-dodecyl mercaptan are emulsified in 68 parts of water under nitrogen, together with 0.08 parts of the sodium salt of the disproportionated abietic acid, whereupon 0.3 parts of potassium persulphate (dissolved in 24 parts of water) are added and the mixture is heated to 65° C. A mixture of 58.14 parts of styrene, 22.61 parts of acrylonitrile and 14.25 parts of tert.-dodecyl mercaptan as well as a solution of 1.92 parts of the sodium salt of the disproportionated abietic acid in over 25 parts of water are metered in over the course of 4 h, whereby the reaction temperature of 65° C. is maintained. After a period of secondary reaction, the latex is coagulated in a cold magnesium sulphate/acetic acid solution. The polymer obtained after drying at 70° C., under vacuum, in a yield of 97%, has a sulphur content of 2.3% and a limiting viscosity of 6.7 ml/g (in dimethyl formamide at 25° C.).

The incorporation of the stabilizers was achieved by adding the substances present in the form of aqueous solutions or aqueous dispersions to the graft rubber latices.

Working-up was carried out in each case by precipitation with a 1:1 mixture of magnesium sulfate and acetic acid in the form of a 1% aqueous solution, washing with water, and drying at 40° C. in vacuo.

The thermal stability of the graft rubbers was measured by determining the oxidative discolouration using a Metrastat PSD 260 test system (manufacturer: PSD-Prüfgeräte-Systeme Dr. Stapfer GmbH, Düsseldorf). The graft rubber powder is stored under air at a specified temperature and the time for discolouration to occur is measured. This simulates the thermal stress exerted during drying.

The stability of the variously stabilized graft rubbers was determined by measuring the time to the formation of brown discoloration at 180° C.

It is clear from the results given in Table 2 that the graft rubbers according to the invention exhibit very good thermal stabilities, in which even very minor overall amounts of organic stabilizers in the product result in improved or comparable thermal stabilities.

TABLE 2

| | | | | | | Overall Amount of | |
|---|---|---|---|---|---|---|---|
| | | | | | | Organic Stabilizer | Metrastat Test |
| | Stabilizer (parts by weight per | | | | | (parts by weight | (time up to the |
| | 100 parts by weight of graft | | | | | per 100 parts by | start of |
| | rubber) | | | | | weight of graft | discoloration, |
| Example | A | B | C | D-1 | D-2 | rubber) | in min) |
| 14 | 0.75 | 0.5 | | | 1.75 | 2.50 | 220 |
| 15 | 0.75 | | | | 2.65 | 3.40 | 100 |
| (Comparison) | | | | | | | |
| 16 | 0.75 | 0.5 | | 0.6 | | 1.35 | 210 |
| 17 | 0.75 | | | 0.9 | | 1.65 | 205 |
| (Comparison) | | | | | | | |
| 18 | 0.75 | 0.5 | 0.8 | | | 1.55 | 140 |
| 19 | 1.0 | 0.5 | 0.8 | | | 1.80 | 150 |
| 20 | 1.0 | | 0.8 | | | 1.80 | 135 |
| (Comparison) | | | | | | | |

### Examples Relating to the Odoriferous Behavior of Stabilized Molding Compositions

Components Employed:

Graft Rubber A1:

Mixture of a first graft rubber latex I (obtained by polymerisation of 50 parts by weight of a styrene/acrylonitrile=73:27 mixture in the presence of 50 parts by weight of a polybutadiene latex with a mean particle size d₅₀ Of 125 nm) and a second graft rubber latex II (obtained by polymerisation of 41 parts by weight of a styrene/acrylonitrile=73:27 mixture in the presence of 59 parts by weight of a polybutadiene latex with a mean particle size d₅₀ of 345 nm) in a weight ratio of graft rubber I to graft rubber II of 1:1, a stabilizer composition K1 in the form of an aqueous dispersion being added to the graft rubber before the working-up.

Graft Rubber A2:

Graft rubber similar to A1, in which a stabilizer composition K2 in the form of an aqueous dispersion was added to the graft rubber before the working-up.

Graft Rubber A3:

Graft rubber similar to A1, in which a stabilizer composition K3 in the form of an aqueous dispersion was added to the graft rubber before the working-up.

Graft Rubber A4:

Graft rubber similar to A1, in which a stabilizer composition K4 in the form of an aqueous dispersion was added to the graft rubber before the working-up.

Graft Rubber A5:

Graft rubber similar to A1, in which a stabilizer composition K5 in the form of an aqueous dispersion was added to the graft rubber before the working-up.

Graft Rubber A6:

Graft rubber similar to A1, in which a stabilizer composition K6 in the form of an aqueous dispersion was added to the graft rubber before the working-up.

Graft Rubber A7:

Graft rubber similar to A1, in which a stabilizer composition K7 in the form of an aqueous dispersion was added to the graft rubber before the working-up.

Stabilizer compositions employed (in each case referred to 100 parts by weight of graft rubber):

K1: 0.75 part of octadecyl-3-(3,5-di-tert.-butyl-4-hydroxyphenyl)-propionate (Irganoxe 1076 from Ciba, Basel, Switzerland), 0.8 part of tris-(2,4-di-tert.-butylphenol)-phosphite (Irgaphos® 168, Ciba, Basel, Switzerland), 0.5 part of sodium hypophosphite

K2: 1.0 part of Irganox® 1076, 0.8 part of Irgaphose 168, 0.5 part of sodium hypophosphite

K3: 1.0 part of Irganox® 1076, 0.8 part of Irgaphose 168

K4: 0.75 part of Irganox® 1076, 1.75 parts of a polymer of styrene, acrylonitrile and t-dodecylmercaptan conforming to D-2 above, 0.5 part of sodium hypophosphite

K5: 0.75 part of Irganox® 1076, 2.65 parts of a polymer of styrene, acrylonitrile and t-dodecylmercaptan conforming to D-2 above,

K6: 0.75 part of Irganox® 1076, 0.6 part of Irganox® PS 800 (Ciba, Basel, Switzerland), 0.5 part of sodium hypophosphite

K7: 0.75 part of Irganox® 1076, 0.9 part of Irganox® PS 800.

Resin Component B:

Random styrene/acrylonitrile copolymer (styrene/acrylonitrile weight ratio 72:28) with a \overline{M}w of ca. 85,000 and \overline{M}w/\overline{M}n−1≦2 obtained by free-radical solution polymerisation.

Molding Compositions

The polymer components described above are mixed in the proportions given in Table 3 with 2 parts by weight of ethylenediamine bisstearylamide and 0.1 part by weight of a silicone oil in an internal kneader and after granulation are processed at a processing temperature of 240° C. into molded articles by injection molding.

The odoriferous behavior was evaluated according to the recommendations of the Verband der Automobilindustrie e.V. (VDA) for determining the odoriferous behavior of materials used in vehicle interiors, dated October 1992 (VDA 270 C3 smell test, see Kraftfahrwesen e.V. (DKF) documentation, Ulrichstraβe 14, Bietigheim-Bissingen).

Evaluation scale for evaluating the smell according to VDA 270

Score 1: not detectable

Score 2: detectable, not unpleasant

Score 3: clearly detectable but still not unpleasant

Score 4: unpleasant

Score 5: extremely unpleasant

Score 6: intolerable

The yellowness index (YI) was determined according to ASTM Norm 1925 (type of light: C, observer: 2°, measurement opening: large area value) according to the equation YI=(128 X-106 Z)/Y, where X,Y,Z=colour coordinates according to DIN 5033. The results are also shown in Table 3.

From Table 3 it is clear that the molding compositions according to the invention have improved yellowness values and in particular exhibit an improved odoriferous behavior to such an extent that the smell is no longer regarded as unpleasant.

TABLE 3
Composition and test values of the molding compositions

| | | | | | | | | | | Smell |
|---|---|---|---|---|---|---|---|---|---|---|
| | A1 | A2 | A3 | A4 | A5 | A6 | A7 | B | | eval. |
| | parts | parts | parts | parts | parts | parts | parts | parts | | (acc. to |
| | by | by | by | by | by | by | by | by | | VDA |
| Example | wt. | wt. | wt. | wt. | wt. | wt. | wt. | wt. | YI | 270 C3) |
| 21 | 30 | — | — | — | — | — | — | 70 | 30 | 2.5 |
| 22 | — | 30 | — | — | — | — | — | 70 | 31 | 2.5 |
| 23 | — | — | 30 | — | — | — | — | 70 | 34 | 3.5 |
| (Comp.) | | | | | | | | | | |
| 24 | — | — | — | 30 | — | — | — | 70 | 34 | 3 |
| 25 | — | — | — | — | 30 | — | — | 70 | 36 | 4.5 |
| (Comp.) | | | | | | | | | | |
| 26 | — | — | — | — | — | 30 | — | 70 | 33 | 3 |
| 27 | — | — | — | — | — | — | 30 | 70 | 35 | 4.5 |
| (Comp.) | | | | | | | | | | |

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A stabilizing composition comprising
a) 1 to 99 parts by weight of at least one antioxidant in the form of a compound the molecular structure of which includes at least one sterically hindered phenol, and
b) 99 to 1 part by weight of at least one water-soluble inorganic salt of an acid selected from the group consisting of hypophosphorous acid (H₃PO₂) and phosphorous acid (H₃PO₃ and HPO₂).

2. The stabilizing composition according to claim 1 further comprising as component c) up to 50 parts by weight of at least one water-insoluble, phosphorus-containing organic compound.

3. The stabilizing composition according to claim 1 further comprising as component d) up to 50 parts by weight of at least one sulfur-containing compound.

4. A process for stabilizing a polymeric resin comprising blending the polymeric resin with the stabilizing composition of claim 1.

5. The process of claim 4 wherein the stabilizing composition or the individual components thereof are added together or individually in the form of an aqueous solution or an aqueous dispersion or an aqueous emulsion or a combination of these aqueous forms, to the polymeric resin material in aqueous emulsion or aqueous suspension.

6. The process of claim 5 wherein the amount of stabilizing composition is 0.1 to 10 parts by weight per 100 parts by weight of polymeric resin.

7. A process for stabilizing a polymeric resin comprising blending a stabilizing composition or the individual components thereof in the form of aqueous solutions or aqueous dispersions or aqueous emulsions or combination of these aqueous forms, with a polymeric resin in aqueous emulsion or aqueous suspension, said stabilizing composition containing a) 1 to 99 parts by weight of at least one antioxidant in the form of a compound the molecular structure of which includes at least one sterically hindered phenol, and b) 99 to 1 part by weight of at least one water-soluble inorganic salt of an acid selected from the group consisting of hypophosphorous acid (H₃PO₂) and phosphorous acid (H₃PO₃ and HPO₂), the amounts of a) and b) totalling 100 parts by weight.

8. The process of claim 7 wherein said a) is octadecyl-3-(3,5-di-tert.-butyl-4-hydroxyphenyl)-propionate and where said b) is sodium hypophosphite.

9. The process of claim 7 wherein the stabilizing composition further contain at least one water-insoluble, phosphorus-containing organic compound as component c).

10. The process of claim 7 wherein the stabilizing composition further contains at least one sulfur-containing compound as component d).

11. Stabilized polymeric resin prepared by the process of claim 4.

12. The process of claim 4 wherein polymeric resins a rubber polymer.

13. The process of claim 12 wherein rubber polymer is at least one member selected from the group consisting of ABS rubber and MBS rubber.

14. Stabilized graft rubber containing
I) at least one rubber having a glass transition temperature ≦1 0° C. as graft base, and
II) at least one grafted phase that is the polymerisation product of at least one vinyl monomer in the presence of the rubber and the stabilizing composition of claim 1.

15. The stabilized graft rubber according to claim 14, wherein the rubber content is from 10 to 90 wt. % relative to the total weight of I) and II).

16. A molding composition comprising the stabilized graft rubber of claim 14 wherein the proportion of I) is 5 to 95 parts by weight and the proportion of II) is 95 to 5 parts by weight.

17. The molding composition of claim 16 wherein the rubber of I) is a polybutadiene.

18. The molding composition of claim 14 wherein said a) is octadecyl-3-(3,5-di-tert.-butyl-4-hydroxyphenyl)-propionate.

19. The molding composition of claim 14 wherein b) is sodium hypophosphite or sodium phosphite.

20. The molding composition according to claim 14, further containing a member selected from the group consisting of aromatic polycarbonates, aromatic polyester carbonates, polyesters and polyamides.

21. A molded article comprising the molding composition of claim 20.
